(19) United States
(12) Patent Application Publication
(10) Pub. No.: US 2025/0286094 A1
(43) Pub. Date: Sep. 11, 2025

(54) FUEL CELL COOLING SYSTEM

(71) Applicant: TOYOTA JIDOSHA KABUSHIKI KAISHA, Toyota-shi (JP)

(72) Inventor: Hiromichi SATO, Hadano-shi (JP)

(73) Assignee: TOYOTA JIDOSHA KABUSHIKI KAISHA, Toyota-shi (JP)

(21) Appl. No.: 18/978,447

(22) Filed: Dec. 12, 2024

(30) Foreign Application Priority Data
Mar. 5, 2024 (JP) 2024-032837

(51) Int. Cl. H01M 8/04746; H01M 8/04007; H01M 8/0432; H01M 8/04701

(52) U.S. Cl. CPC H01M 8/04768; H01M 8/04074; H01M 8/04358; H01M 8/04723

(57) ABSTRACT

A fuel cell cooling system includes a first cooling channel, a fuel cell, a second cooling channel, radiator, an intercooler, an intermediate heat exchanger including a first heat exchange channel and a second heat exchange channel, a parallel channel, and a valve. During power generation by the fuel cell, when the temperature of the coolant in the first cooling channel is lower than a first reference value, a first operation is performed in which coolant is circulated in the first cooling channel over a path passing through the fuel cell and the first heat exchange channel, and also coolant is circulated in the second cooling channel over a path passing through the radiator, the parallel channel and the intercooler. When the temperature of the coolant in the first cooling channel is higher than the first reference value, a second operation is performed.

### CROSS-REFERENCE TO RELATED APPLICATION

This application claims priority to Japanese Patent Application No. 2024-032837 filed on Mar. 5, 2024, incorporated herein by reference in its entirety.

### BACKGROUND

### 1. Technical Field

The technology disclosed in the present specification relates to a fuel cell cooling system.

### 2. Description of Related Art

A fuel cell system disclosed in Japanese Unexamined Patent Application Publication No. 2002-33108 (JP 2002-33108 A) has a first cooling channel and a second cooling channel for circulating coolant. A fuel cell is provided on the first cooling channel. A radiator is provided on the second cooling channel. An intermediate heat exchanger is provided across the first cooling channel and the second cooling channel. The intermediate heat exchanger exchanges heat between the first cooling channel and the second cooling channel.

### SUMMARY

In a fuel cell system, there are cases in which an intercooler is provided to cool compressed air that is supplied to a fuel cell. In the technology of JP 2002-33108 A, when the intercooler is provided on the second cooling channel, the coolant cooled by the radiator can be supplied to the intercooler and the intermediate heat exchanger. Heat generated in the fuel cell during power generation is transferred to the intermediate heat exchanger by the coolant flowing through the first cooling channel. The intermediate heat exchanger cools the coolant in the first cooling channel by heat exchange with the coolant in the second cooling channel (i.e., coolant cooled by the radiator). Also, the intercooler cools compressed air by heat exchange with the coolant in the second cooling channel (i.e., coolant cooled by the radiator).

When the fuel cell is started in a low-temperature environment, temperature of the fuel cell is low immediately after the start-up, and power generation efficiency is low. Further, when the fuel cell is started, coolant needs to be supplied to the intercooler. In the fuel cell system described above, when the coolant is supplied to the intercooler, the coolant is also supplied to the intermediate heat exchanger. This cools the coolant in the first cooling channel by the intermediate heat exchanger, and the temperature of the fuel cell does not readily rise. Accordingly, the power generation efficiency of the fuel cell does not readily rise. In this way, when the intercooler is provided on the second cooling channel, there is a problem in that the temperature of the fuel cell in a low-temperature environment does not readily rise. The present specification proposes technology capable of raising temperature of a fuel cell while supplying coolant to an intercooler.

### First Aspect

A fuel cell cooling system disclosed in the present specification includes
a first cooling channel through which coolant circulates,
a fuel cell provided on the first cooling channel,
a second cooling channel through which coolant circulates,
a radiator provided on the second cooling channel,
an intercooler provided on the second cooling channel, and
an intermediate heat exchanger that includes a first heat exchange channel making up a portion of the first cooling channel and a second heat exchange channel making up a portion of the second cooling channel, and that performs heat exchange between the first heat exchange channel and the second heat exchange channel,
in which
the second cooling channel includes a parallel channel that is connected in parallel to the intermediate heat exchanger and a valve that opens and closes the second heat exchange channel,
during power generation by the fuel cell, when temperature of the coolant of the first cooling channel is lower than a first reference value, a first operation is performed in which coolant is circulated in the first cooling channel over a path passing through the fuel cell and the first heat exchange channel, and also coolant is circulated in the second cooling channel over a path passing through the radiator, the parallel channel, and the intercooler, in a state in which the second heat exchange channel is closed, and
during power generation by the fuel cell, when the temperature of the coolant in the first cooling channel is higher than the first reference value, a second operation is performed in which the coolant is circulated in the first cooling channel over the path passing through the fuel cell and the first heat exchange channel, and also coolant is circulated in the second cooling channel over a path passing through the radiator, the second heat exchange channel, and the intercooler.

In this fuel cell cooling system, when the temperature of the coolant in the first cooling channel is lower than the first reference value during power generation by the fuel cell, the first operation is performed. In the first operation, the coolant is circulated in the second cooling channel over the path passing through the radiator, the parallel channel, and the intercooler, in the state in which the second heat exchange channel is closed. The intercooler can cool the compressed air by the coolant circulating in the second cooling channel. Also, the second heat exchange channel is closed, and accordingly the coolant does not flow into the intermediate heat exchanger. Thus, in the intermediate heat exchanger, heat exchange does not readily occur between the first heat exchange channel and the second heat exchange channel. As a result, the coolant in the first cooling channel is hardly cooled at all in the intermediate heat exchanger, and accordingly the temperature of the fuel cell can be efficiently raised. As described above, according to this fuel cell cooling system, the temperature of the fuel cell can be raised while the coolant is supplied to the intercooler.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a fuel cell cooling system;

FIG. 2 is an explanatory diagram of a path;

FIG. 3 is an explanatory diagram of a path;

FIG. 4 is a flow chart of an operation selection process of the fuel cell cooling system; and

FIG. 5 is a flowchart of an operation selection process of the fuel cell cooling system.

### DETAILED DESCRIPTION OF EMBODIMENTS

Following the above aspect 1, additional configurations of the fuel cell cooling system disclosed herein are described below.

### Second Aspect

The fuel cell cooling system according to the first aspect, wherein the intercooler is provided in the parallel channel, and in the second operation, the coolant flows in parallel to the second heat exchange channel and the parallel channel.

### Third Aspect

In the fuel cell cooling system according to the first or second aspect, in the first operation, when the temperature of the coolant in the first cooling channel is lower than the second reference value, the circulating speed of the coolant in the first cooling channel is slower than when the temperature of the coolant in the first cooling channel is higher than the second reference value.

### Fourth Aspect

In the fuel cell cooling system according to any one of the first to third aspects, in the second operation, when the temperature of the coolant in the first cooling channel is higher than the third reference value, the flow rate of the coolant in the second heat exchange channel is made faster than when the temperature of the coolant in the first cooling channel is lower than the third reference value.

According to the second aspect, since the coolant cooled by the radiator flows in parallel to the intercooler and the second heat exchange channel, the intercooler and the intermediate heat exchanger can be operated efficiently.

According to the third aspect, when the temperature of the coolant in the first cooling channel is low in the first operation, the temperature of the fuel cell can be raised faster.

According to the fourth aspect, when the temperature of the coolant in the first cooling channel is high in the second operation, the fuel cell can be cooled more effectively.

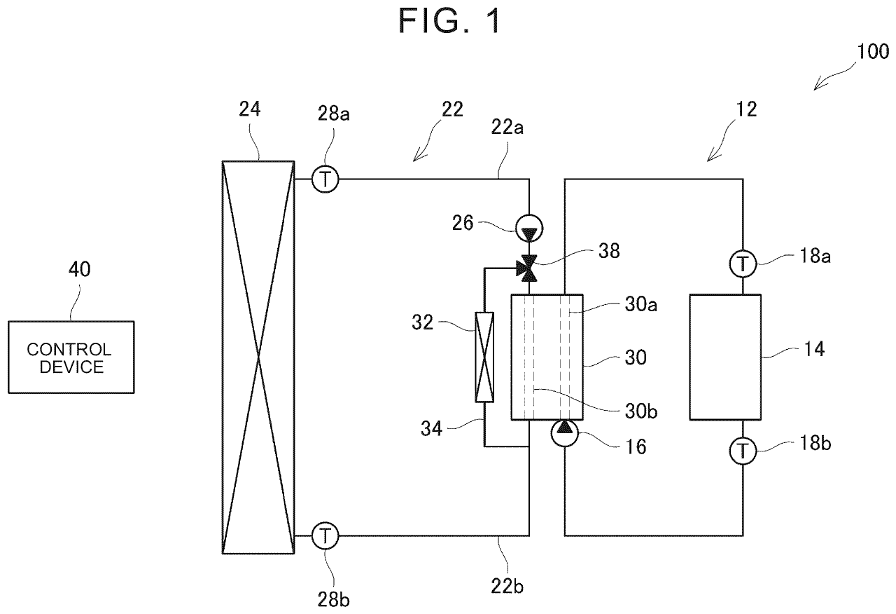

The fuel cell cooling system 100 shown in FIG. 1 is mounted on a device (for example, a fuel cell electric vehicle) using a fuel cell as a power source. The fuel cell cooling system 100 includes a first cooling channel 12, a second cooling channel 22, and an intermediate heat exchanger 30.

The intermediate heat exchanger 30 has a first heat exchange channel 30a and a second heat exchange channel 30b. The first heat exchange channel 30a is a part of the first cooling channel 12, and the second heat exchange channel 30b is a part of the second cooling channel 22. The intermediate heat exchanger 30 causes heat exchange between the first heat exchange channel 30a and the second heat exchange channel 30b. That is, the intermediate heat exchanger 30 causes heat exchange between the first cooling channel 12 and the second cooling channel 22.

A fuel cell 14 is provided in the first cooling channel 12. The fuel cell 14 is supplied with compressed air from an air compressor (not shown) and hydrogen from a tank (not shown). The fuel cell 14 generates electric power by reacting oxygen with hydrogen, and supplies electric power to a motor (not shown). The fuel cell 14 is cooled by the coolant in the first cooling channel 12.

The first cooling channel 12 is an annular channel. The first cooling channel 12 is provided with a pump 16 and temperature sensors 18a, 18b. The pump 16 delivers the coolant from the installation position toward the intermediate heat exchanger 30. When the pump 16 is operated, the coolant circulates in the first cooling channel 12.

The temperature sensor 18a is provided in the first cooling channel 12 upstream of the fuel cell 14. The temperature sensor 18a detects the temperature of the coolant flowing into the fuel cell 14 (hereinafter referred to as FC inlet temperature). The temperature sensor 18b is provided downstream of the fuel cell 14 in the first cooling channel 12. The temperature sensor 18b detects the temperature of the coolant discharged from the fuel cell 14 (hereinafter referred to as FC outlet temperature).

A radiator 24 is provided in the second cooling channel 22. The radiator 24 cools the coolant flowing in the second cooling channel 22 by heat exchange with the outside air.

The second cooling channel 22 includes a channel 22a, a channel 22b, a parallel channel 34, and a three-way valve 38. The upstream end of the channel 22a is connected to the downstream end of the coolant channel in the radiator 24. The downstream end of the channel 22a is connected to the upstream end of the second heat exchange channel 30b and the upstream end of the parallel channel 34 via the three-way valve 38. The parallel channel 34 is arranged in parallel to the second heat exchange channel 30b. An upstream end of the channel 22b is connected to a downstream end of the second heat exchange channel 30b. The downstream end of the channel 22b is connected to the upstream end of the coolant channel in the radiator 24.

The three-way valve 38 opens and closes the second heat exchange channel 30b. According to the opening degree of the three-way valve 38, the flow rate of the coolant flowing in each of the second heat exchange channel 30b and the parallel channel 34 is adjusted.

An intercooler 32 is provided in the parallel channel 34. The intercooler 32 cools the compressed air supplied to the fuel cell 14 by heat exchange with the coolant flowing through the parallel channel 34.

The fuel cell cooling system 100 includes a pump 26, a temperature sensor 28a, and a temperature sensor 28b. The pump 26 is provided in the channel 22a. The pump 26 delivers the coolant from the installation position toward the intermediate heat exchanger and the intercooler 32. When the pump 26 is operated, the coolant circulates in the second cooling channel 22.

The temperature sensor 28a is provided in the channel 22a. The temperature sensor 28a detects a temperature of the coolant discharged from the radiator 24 (hereinafter, referred to as a radiator outlet temperature). The temperature sensor 28b is provided in the channel 22b. The temperature sensor 28b detects a temperature of the coolant flowing into the radiator 24 (hereinafter, referred to as a radiator inlet temperature).

The fuel cell cooling system 100 includes a control device 40. The control device 40 controls the pump 16, the pump 26, and the three-way valve 38 based on the temperature of the coolant in the first cooling channel 12 and the temperature of the coolant in the second cooling channel 22.

The fuel cell 14 is supplied with compressed air from an air compressor (not shown) and hydrogen from a tank (not shown). The fuel cell 14 generates electric power by reacting oxygen with hydrogen. During power generation of the fuel cell 14, the fuel cell cooling system 100 may perform the warm-up control and the normal control described below.

The warm-up control is executed when the temperature of the fuel cell 14 is low. In the warm-up control, the control device 40 activates the pump 16. When the pump 16 is operated, the coolant circulates in the first cooling channel 12 in the order of the intermediate heat exchanger 30 (that is, the first heat exchange channel 30a) and the fuel cell 14. Therefore, the heat generated by the power generation of the fuel cell 14 is transferred to the first heat exchange channel 30a by the coolant in the first cooling channel 12.

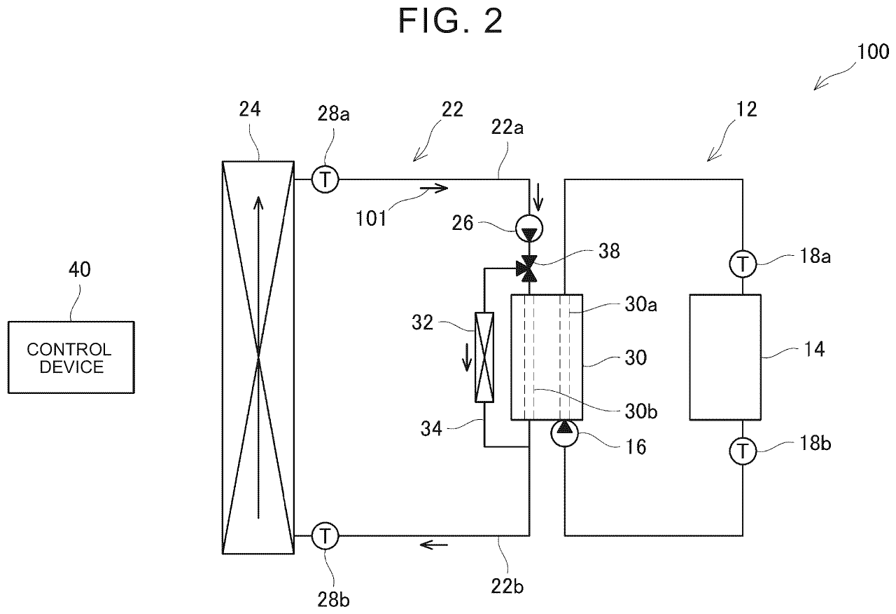

In the warm-up control, the control device 40 operates the pump 26. Furthermore, the control device 40 controls the three-way valve 38 with the second heat exchange channel 30b closed. Therefore, the coolant circulates in the path 101 indicated by the arrow in FIG. 2. In the path 101, the coolant delivered by the pump 26 circulates through the intercooler 32 (i.e., the parallel channel 34), the channel 22b, the radiator 24, and the channel 22a through the second cooling channel 22. In this case, the coolant does not flow in the second heat exchange channel 30b. Therefore, in the intermediate heat exchanger 30, the coolant in the first heat exchange channel 30a is hardly cooled. In the intercooler 32, the compressed air supplied to the fuel cell 14 is cooled by heat exchange with the coolant flowing through the parallel channel 34.

As described above, in the warm-up control, the compressed air supplied to the fuel cell 14 is cooled by the intercooler 32, while the coolant in the first cooling channel 12 is hardly cooled in the intermediate heat exchanger 30. Therefore, the temperature of the fuel cell 14 tends to increase.

Normal control is performed when the temperature of the fuel cell 14 is high. In normal control, the control device 40 activates the pump 16. Therefore, similarly to the warm-up control, the coolant circulates in the first cooling channel 12. Therefore, the heat generated by the power generation of the fuel cell 14 is transferred to the intermediate heat exchanger 30 (that is, the first heat exchange channel 30a) by the coolant in the first cooling channel 12.

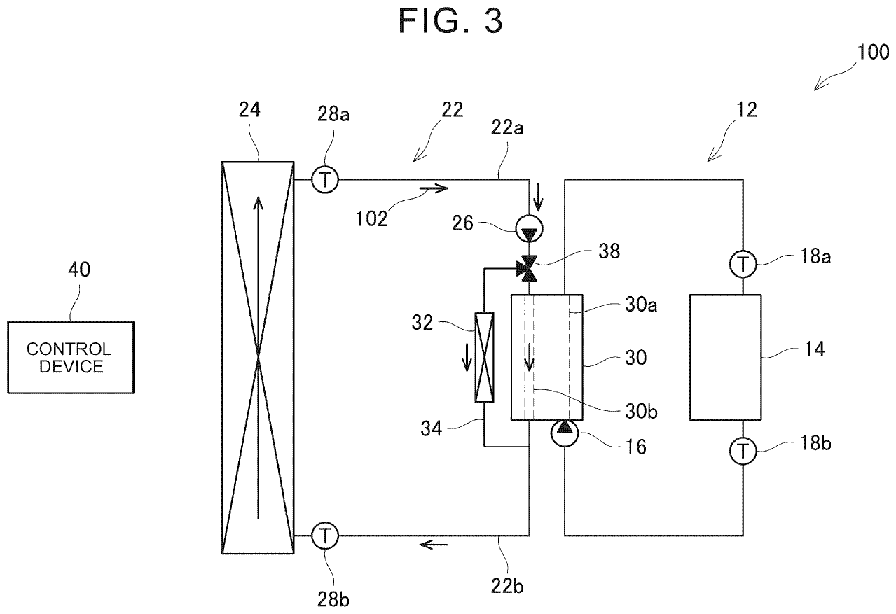

In normal control, the control device 40 activates the pump 26. In addition, the control device 40 adjusts the opening degree of the three-way valve 38, and controls the flow of the coolant in parallel with the second heat exchange channel 30b and the parallel channel 34. Therefore, the coolant circulates in the path 102 indicated by the arrow in FIG. 3. In path 102, the coolant pumped by pump 26 flows in parallel to intercooler 32 (i.e., parallel channel 34) and intermediate heat exchanger 30 (i.e., second heat exchange channel 30b). The coolant that has passed through the intermediate heat exchanger 30 and the intercooler 32 then flows to the radiator 24. The radiator 24 cools the coolant in the second cooling channel 22 by heat exchange with the outside air. Therefore, the coolant cooled by the radiator 24 flows to the intermediate heat exchanger 30 and the intercooler 32. The intermediate heat exchanger 30 cools the coolant in the first cooling channel 12 by heat exchange between the first cooling channel 12 and the second cooling channel 22. Since the coolant in the second cooling channel 22 is cooled by the radiator 24, the intermediate heat exchanger 30 can efficiently cool the coolant in the first cooling channel 12. The intercooler 32 cools the compressed air supplied to the fuel cell 14 by heat exchange with the coolant flowing through the parallel channel 34.

As described above, in the normal control, the coolant in the first cooling channel 12 can be effectively cooled in the intermediate heat exchanger 30 while the compressed air supplied to the fuel cell 14 is cooled by the intercooler 32.

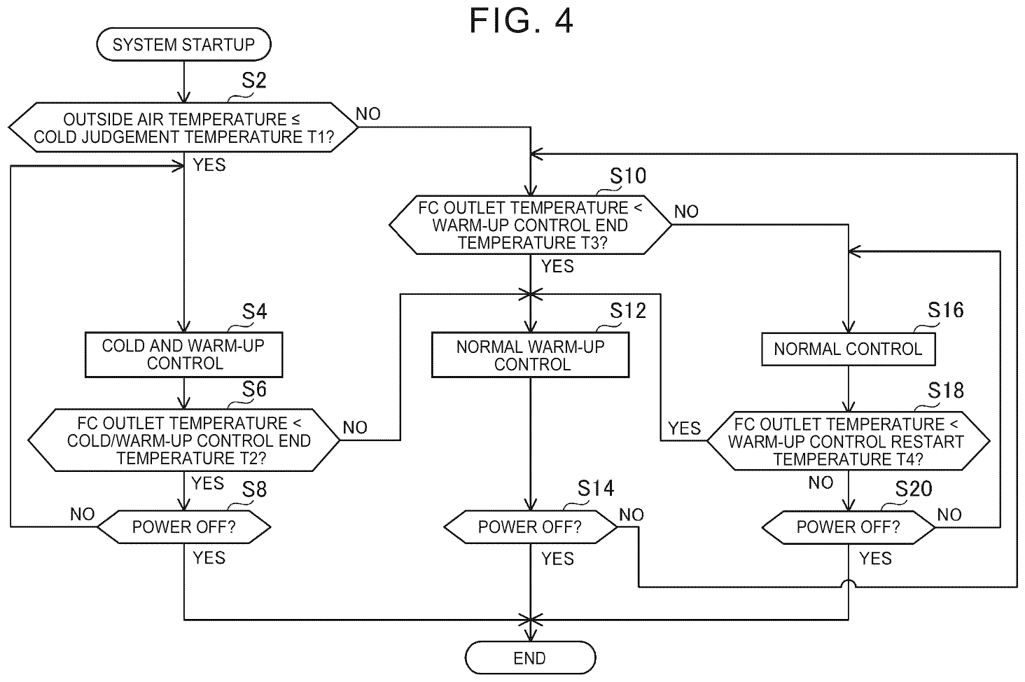

FIG. 4 illustrates in more detail the processing performed by the control device 40 during operation of the fuel cell 14.

In S2, the control device 40 measures the outside air temperature by a temperature sensor (not shown). The control device 40 determines whether the outside air temperature is equal to or lower than the cold determination temperature T1. When the vehicle is stopped, the temperature of the coolant substantially coincides with the outside air temperature. Therefore, S2 process is equivalent to determining whether the temperature of the coolant flowing through the first cooling channel 12 is equal to or lower than the cold determination temperature T1.

When the outside air temperature is equal to or lower than the cold determination temperature T1 (YES in S2), the control device 40 performs the cold/warm-up control in S4. In the cold/warm-up control, the control device 40 performs the above-described warm-up control. In the cold/warm-up control, the control device 40 controls the discharge flow rate of the pump 26 in accordance with the radiator outlet temperature and the heat capacity of the compressed air flowing into the intercooler 32. Further, in the cold/warm-up control, the control device 40 controls the output current of the fuel cell 14 and the discharge flow rate of the pump 16 in accordance with FC inlet temperature. At this time, the discharge flow rate of the pump 16 is controlled to a low value. As described above, in the warm-up control, the temperature of the fuel cell 14 tends to increase. In particular, in the cold/warm-up control, since the discharge flow rate of the pump 16 is low, it is difficult to transfer heat from the fuel cell 14 to the coolant. Therefore, the temperature of the fuel cell 14 tends to increase. As described above, when the air temperature is lower than or equal to the cold determination temperature T1, the temperature of the fuel cell 14 is rapidly increased by performing the cold/warm-up control. This increases the power generation efficiency of the fuel cell 14.

When FC outlet temperature is lower than the cold/warm-up control end temperature T2, the control device 40 performs cold/warm-up control (that is, NO in YES, S8 in S6) until the power of the vehicles is turned OFF. The control device 40 performs S12 when FC outlet temperature exceeds the cold/warm-up control end temperature T2 (NO in S6).

If the outside air temperature is higher than the cold determination temperature T1 in S2 (NO in S2), the control device 40 determines whether FC outlet temperature is lower than the warm-up control end temperature T3 in S10. That is, the control device 40 determines whether the temperature of the coolant flowing through the first cooling channel 12 is lower than the warm-up control end temperature T3. The warm-up control end temperature T3 is a temperature higher than the cold determination temperature T1 and the cold/warm-up control end temperature T2.

When FC outlet temperature is lower than the warm-up control end temperature T3 (YES in S10), the control device 40 performs the normal warm-up control in S12. In the normal warm-up control, the control device 40 performs the above-described warm-up control. In the normal warm-up control, the control device 40 controls the discharge flow rate of the pump 26 in accordance with the radiator outlet temperature and the heat capacity of the compressed air flowing into the intercooler 32. In the normal warm-up control, the control device 40 controls the output current of the fuel cell 14 and the discharge flow rate of the pump 16 in accordance with FC inlet temperature. In the normal warm-up control, the discharge flow rate of the pump 16 is controlled to a high value (that is, a value higher than S4). As described above, in the warm-up control, the temperature of the fuel cell 14 tends to increase. However, in the normal warm-up control, since the discharge flow rate of the pump 16 is high, the temperature of the fuel cell 14 is less likely to increase than in the cold-warm-up control. In this way, in a state where the temperature of the fuel cell 14 is high to some extent, the power generation amount of the fuel cell 14 is lowered and the flow rate of the coolant is increased more than in the cold/warm-up control, thereby reducing the temperature gradient in the fuel cell 14.

When FC outlet temperature is lower than the warm-up control end temperature T3, the control device 40 performs the normal warm-up control until the power of the vehicle is turned OFF (that is, YES, S14 and NO in S10). The control device 40 performs S16 when FC outlet temperature exceeds the warm-up control end temperature T3 (NO in S10).

In S16, the control device 40 performs the above-described normal control. At this time, the opening degree of the three-way valve 38 is fixed. In this way, when FC outlet temperature is high (that is, when the temperature of the fuel cell 14 is high), the fuel cell 14 is effectively cooled by the normal control. This suppresses excessive temperature rise of the fuel cell 14.

When FC outlet temperature is higher than the warm-up control restart temperature T4, the control device 40 performs the normal control (that is, NO in NO, S20 in S18) until the power of the vehicle is turned OFF. The warm-up control restart temperature T4 is a temperature lower than the warm-up control end temperature T3. When FC outlet temperature becomes lower than the warm-up control restart temperature T4 (YES in S18), the control device 40 performs the normal warm-up control in S12.

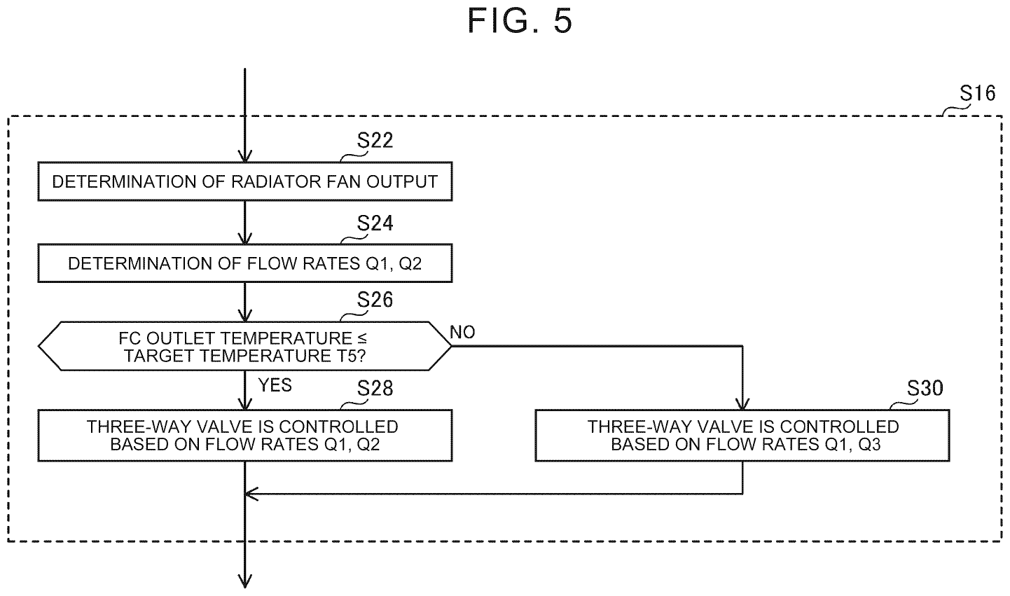

In the above-described embodiment, the opening degree of the three-way valve 38 was fixed by S16. However, the opening degree of the three-way valve 38 may be adjusted based on the calorific value of the fuel cell 14, FC outlet temperature, and the heat capacity of the compressed air flowing into the intercooler 32. In this instance, the control device 40 executes the process of FIG. 5 (i.e., from S22 to S30) during execution of S16 (i.e., during execution of the normal control).

In S22, the control device 40 determines the power of the radiator 24 according to the amount of heat generated by the fuel cell 14 and the vehicle speed. Therefore, the radiator 24 appropriately cools the coolant.

Next, the control device 40 determines a quantity Q1 (hereinafter, referred to as a flow rate Q1) of the coolant flowing to the intercooler 32 in accordance with the heat capacity of the compressed air flowing into the intercooler 32 in S24 and the radiator outlet temperature. In addition, the control device 40 determines a quantity Q2 (hereinafter, referred to as a flow rate Q2) of the coolant flowing to the intermediate heat exchanger 30 in accordance with the quantity of heat generated by the fuel cell 14.

Next, the control device 40 determines whether FC outlet temperature is lower than the target temperature T5 in S26. That is, the control device 40 determines whether the temperature of the coolant flowing through the first cooling channel 12 is lower than the target temperature T5. The control device 40 performs S28 when FC outlet temperature is equal to or lower than the target temperature T5 (when S26 is YES).

In S28, the control device 40 adjusts the opening degree of the three-way valve 38 and the output of the pump 26 based on the flow rates Q1, Q2 (i.e., the flow rate) determined by S24. Since the flow rate Q2 is determined according to the calorific value of the fuel cell 14, heat is efficiently exchanged between the coolant flowing through the intermediate heat exchanger 30 and the coolant flowing through the first cooling channel 12. Therefore, the fuel cell 14 is efficiently cooled. Further, the flow rate Q1 was determined according to the heat capacity of the compressed air flowing into the intercooler 32 and the radiator outlet temperature. As a result, in the intercooler 32, the compressed air supplied to the fuel cell 14 is cooled more effectively.

The control device 40 performs S30 when FC outlet temperature exceeds the target temperature T5 (when S26 is NO).

In S30, the control device 40 determines the flow rate Q3 (i.e., the flow speed) of the coolant flowing to the intermediate heat exchanger 30 so as to satisfy the following relational expression.

$$Q 3 = Q 2 \cdot \{ 1 + a \cdot ( FC outlet temperature - T 5 ) \}$$

The value of the flow rate Q3 is a value larger than the flow rate Q2.

S30 then adjusts the opening of the three-way valve 38 and the power of the pump 26 based on the determined flow rate Q1 and flow rate Q3. Since the flow rate Q3 is larger than the flow rate Q2, in S30, heat is more likely to be exchanged between the coolant flowing through the intermediate heat exchanger 30 and the coolant flowing through the first cooling channel 12 than S28. Therefore, the fuel cell 14 can be cooled more effectively.

In the above-described embodiment, the three-way valve 38 is provided at a connecting portion between the channel 22a, the parallel channel 34, and the upstream end of the second heat exchange channel 30b. However, the three-way valve 38 may be provided at a connecting portion between the channel 22b, the parallel channel 34, and the downstream end of the second heat exchange channel 30b.

In the above-described embodiment, the channel changing device for changing the path of the coolant in the second cooling channel 22 by the three-way valve 38 is configured, the channel changing device may be configured by other devices. Further, in the embodiment, the three-way valve 38 is a solenoid valve, but the channel changing device may be configured by a device that does not use electricity. For example, a channel changing device may be configured by a device that switches a channel by thermal expansion of a material, such as a thermostat.

In the embodiment, the intercooler 32 is provided in the parallel channel 34. However, the intercooler 32 may be provided in the channel 22a. Further, the intercooler 32 may be a channel 22b, and may be provided between the parallel channel 34 and the radiator 24. That is, the coolant may flow in series with the intermediate heat exchanger 30 and the intercooler 32.

In S4, S12 of the above-described embodiment, the control device 40 controls the discharge flow rate of the pump 16 in accordance with FC inlet temperature. However, in S4, S12, the discharge flow rate of the pump 16 may be mapped.

In S4, S12 of the above-described embodiment, the discharge flow rate of the pump 26 is controlled in accordance with the radiator outlet temperature and the heat capacity of the compressed air flowing into the intercooler 32. However, in S4, S12, the discharge flow rate of the pump 26 may be mapped.

In the above-described embodiment, the output of the fan of the radiator 24 is determined in accordance with the amount of heat generated by the fuel cell 14 and the vehicle speed. However, the amount of heat dissipation of the radiator 24 may be calculated from the radiator outlet temperature and the radiator inlet temperature, and the output of the fan of the radiator 24 may be determined from the comparison between the amount of heat generation of the fuel cell 14 and the amount of heat dissipation of the radiator 24.

The cold/warm-up control and the normal warm-up control of the embodiment are examples of the first operation. Further, the normal control is an example of the second operation.

The warm-up control end temperature T3 of the embodiment is an example of the first reference value. The cold determination temperature T1 of the embodiment is an example of the second reference value. The target temperature T5 is an exemplary third reference value.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A fuel cell cooling system comprising:
a first cooling channel through which coolant circulates;
a fuel cell provided on the first cooling channel;
a second cooling channel through which coolant circulates;
a radiator provided on the second cooling channel;
an intercooler provided on the second cooling channel; and
an intermediate heat exchanger that includes a first heat exchange channel making up a portion of the first cooling channel and a second heat exchange channel making up a portion of the second cooling channel, and that performs heat exchange between the first heat exchange channel and the second heat exchange channel, wherein
the second cooling channel includes a parallel channel that is connected in parallel to the intermediate heat exchanger and a valve that opens and closes the second heat exchange channel,
during power generation by the fuel cell, when temperature of the coolant of the first cooling channel is lower than a first reference value, a first operation is performed in which coolant is circulated in the first cooling channel over a path passing through the fuel cell and the first heat exchange channel, and also coolant is circulated in the second cooling channel over a path passing through the radiator, the parallel channel, and the intercooler, in a state in which the second heat exchange channel is closed, and
during power generation by the fuel cell, when the temperature of the coolant in the first cooling channel is higher than the first reference value, a second operation is performed in which the coolant is circulated in the first cooling channel over the path passing through the fuel cell and the first heat exchange channel, and also coolant is circulated in the second cooling channel over a path passing through the radiator, the second heat exchange channel, and the intercooler.

2. The fuel cell cooling system according to claim 1, wherein:
the intercooler is provided on the parallel channel; and
in the second operation, the coolant flows in parallel over the second heat exchange channel and the parallel channel.

3. The fuel cell cooling system according to claim 1, wherein, in the first operation, when the temperature of the coolant in the first cooling channel is lower than a second reference value, a circulating rate of the coolant in the first cooling channel is reduced as compared to when the temperature of the coolant in the first cooling channel is higher than the second reference value.

4. The fuel cell cooling system according to claim 1, wherein, in the second operation, when the temperature of the coolant in the first cooling channel is higher than a third reference value, a flow rate of the coolant in the second heat exchange channel is increased as compared to when the temperature of the coolant in the first cooling channel is lower than the third reference value.
